(19) United States
(12) Patent Application Publication
(10) Pub. No.: US 2003/0038183 A1
(43) Pub. Date: Feb. 27, 2003

(54) Spray gun for enteric coating and process for producing enteric coating preparation

(75) Inventors: Yuichi Nishiyama, Niigata-ken (JP); Kazuhisa Hayakawa, Niigata-ken (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Shin-Etsu Chemical Co., Ltd.

(21) Appl. No.: 10/261,906

(22) Filed: Oct. 1, 2002

Related U.S. Application Data
(62) Division of application No. 09/938,055, filed on Aug. 23, 2001.

(30) Foreign Application Priority Data
Aug. 25, 2000 (JP) 2000-254836

(51) Int. Cl. A62C 5/02

(52) U.S. Cl. 239/10

(57) ABSTRACT

Provided is an enteric coating technique capable of carrying out enteric coating without using an organic solvent and without causing a spray gun to clog, while keeping a equipment cost low. More specifically, from a spray gun comprising a nozzle for spraying an enteric polymer dispersion and/or solution and a nozzle for spraying a plasticizer solution, these solutions are sprayed simultaneously and separately through the nozzles. A mixture of these solutions thus obtained during spraying is applied to a preparation.

### BACKGROUND OF THE INVENTION

1. Field of the Invention

The present invention relates to an improved process for producing an enteric coated preparation and also a spray nozzle of a coating solution for spraying a coating composition.

2. Description of the Related Art

As a process for producing enteric coated preparations, conventionally and widely known is a process for applying a coating solution, which has been obtained by dissolving an enteric coating material in an organic solvent, to tablets, granules or capsules. Since this process requires use of a large amount of an organic solvent, however, it is accompanied with the problems such as a danger of fire or explosion, a threat to safety and health for workers, and environmental pollution due to dispersion of the organic solvent in the air. In addition, it is disadvantageous in cost.

Accordingly, there is a demand for the development of art for producing an enteric coated preparation without using an organic solvent. From this viewpoint, Japanese Patent Provisional Publication (JP-A) No. 55-98120/1980 (U.S. Pat. No. 4,287,221) discloses a process wherein a coating solution is obtained by dispersing hydroxypropyl methyl cellulose phthalate powders having an average particle size of 100 μm or less in water of 25° C. or less containing triacetin, and sprayed from a spray nozzle to a preparation, while the resulting sprayed preparation is simultaneously dried. Japanese Patent Publication (JP-B) No. 3-80767/1991, discloses a process wherein triethyl citrate as a plasticizer is used.

The above-described processes permit coating without using an organic solvent. However, they have a problem of clogging the spray gun. Since a pan in which preparations are rolled is under a heated condition for drying, a solution of a coating composition is heated in a pipe and a nozzle in the pan, the pipe being for leading the solution to a spray nozzle placed in the pan. Consequently, a plasticizer and an enteric polymer happen to form agglomerates owing to their interaction so that the spray gun is clogged.

With a view to overcoming the problem, Japanese Patent Publication (JP-B) No. 5-9407/1993 discloses a process wherein an enteric polymer dispersion is sprayed from one spray gun, while simultaneously a plasticizer solution is sprayed from another spray gun. However, this process is accompanied with the problems that it requires two spray guns which increases an equipment installation cost, and that the yield of the polymer sprayed is inferior because it takes time to obtain a uniform mixture with the plasticizer.

### SUMMARY OF THE INVENTION

An object of the present invention is to provide an enteric coating technique capable of applying enteric coating to preparations even without using an organic solvent and without causing a spray gun to clog, while keeping an equipment cost low.

With a view toward overcoming the above-described problems, the present inventors have carried out an extensive investigation. As a result, provided is a spray gun which can be used when coating materials of an enteric polymer dispersion and/or solution and a plasticizer solution are sprayed to preparations. The spray has a nozzle for spraying the enteric polymer dispersion and/or solution and a nozzle for spraying the plasticizer solution. Then, an enteric polymer dispersion and/or solution and a plasticizer solution are sprayed simultaneously but separately from the nozzle openings of a spray gun so that they can be mixed during spraying and coated. Consequently, the preparations having gastro-resistant but enteric coating is obtained without a spraying gun clogged and without using an organic solvent, while keeping an equipment cost low. Thus, the present inventors have the completed the invention.

According to the present invention, coating can be effected without a spray gun clogged and without using an organic solvent, while keeping a equipment cost low.

### BRIEF DESCRIPTION OF THE DRAWINGS

FIG. 1 is a cross-sectional view illustrating one example of a spray gun according to the present invention.

### DETAILED DESCRIPTION OF THE PREFERRED INVENTION

The present invention will hereinafter be described more specifically. Howeve, it should be construed that the present invention is not limited to the following embodiments.

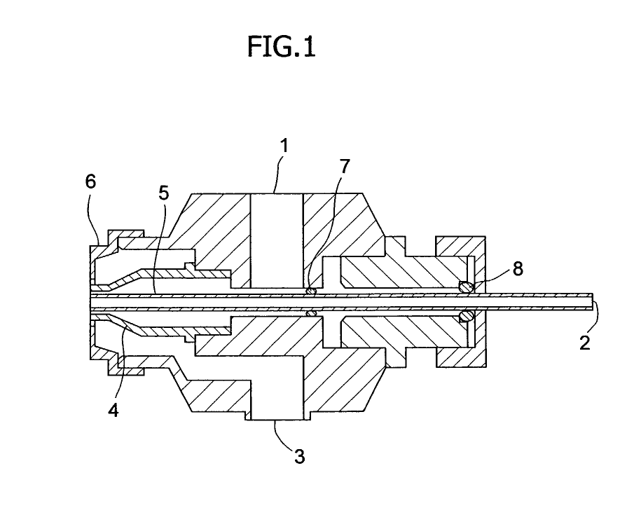

One example of a spray gun according to the present invention is illustrated in FIG. 1.

The spray gun has a construction such that an enteric polymer dispersion and/or enteric polymer solution and a plasticizer solution, which can be selected suitably, can be introduced by a pump from Inlet 1 for Liquid A and Inlet 2 for Liquid B. Inlet 1 for Liquid A and Inlet 2 for Liquid B are connected with nozzle openings of Nozzle-A 4 and Nozzle-B 5, respectively, from which Liquids A and B are discharged by spraying. Air from Air inlet 3 is discharged from the nozzle opening of Air nozzle (cap) 6. In FIG. 1, the nozzle opening of Nozzle-A 4, the nozzle opening of Nozzle-B 5 and the nozzle opening of Air nozzle form a substantially concentric circle, being arranged from the inside toward the outside. O-ring 7 and packing 8 are also shown in FIG. 1. Liquid A may be an enteric polymer dispersion and/or enteric polymer solution, and Liquid B may be a plasticizer solution. Alternatively, Liquid A may be the plasticizer solution and Liquid B may be the enteric polymer dispersion and/or enteric polymer solution.

No particular limitation is imposed on the pump for introducing the enteric polymer dispersion and/or solution and the plasticizer solution. A conventionally employed pump can be used, while the preferred pump is, for example, a gear pump or a tube pump.

Although no particular limitation is imposed on the quality of the material of the spray gun used in the present invention insofar as it has water resistance and is not dissolved or melted in a plasticizer at room temperature to about 100° C., a heat resistant and anti-corrosive material such as stainless steel or silicone is preferred. A water system is preferred in consideration of fire or explosion risk elimination, safety and health of workers, and environmental protection. In the case where an organic solvent is used, organic solvent resistance is required.

Although there is no particular limitation imposed on the shape or diameter of the nozzle insofar as spraying can be conducted, a diameter or wall-to-wall distance of a pipe of about 0.1 to 5 mm which can facilitate spraying is preferred.

Although no particular limitation is imposed on the liquid feed rate of the spray gun, the liquid feed rate of several grams per minute to several hundred grams per minute is preferred, because it is a measure for smooth coating. The spray gun may have a construction such that air or gas can be fed to the nozzle for spraying. Although no particular limitation is imposed on the feed rate of this air or gas insofar as spraying can be conducted, the feed rate of several tens to several hundreds liters per minute is preferred. Although no particular limitation is imposed on the kind of the gas other than air, inert gases free from interaction with a medicament such as nitrogen and helium are preferred.

The conventional enteric polymer may be used in the present invention. Examples thereof include hydroxypropyl methyl cellulose phthalate (HPMCP) and cellulose acetate phthalate (CAP) each specified in Japanese Pharmacopoeia, and hydroxypropyl methyl cellulose acetate succinate (HPMCAS), carboxymethyl ethyl ether (CMEC) and methyl acrylate-ethyl methacrylate copolymer (another name: Eudragit) each specified in Japanese Pharmaceutical Excipients Standards. Although no particular limitation is imposed on the particle size of such an enteric polymer used in the form of a dispersion insofar as it does not clog the spray gun, the average particle size is usually 100 μm or less, preferably 50 μm or less. The enteric polymer may also be used after dissolved in weakly alkali water such as aqueous ammonia.

In the present invention, the enteric polymer dispersion may be prepared by dispersing the enteric polymer in a predetermined amount of water while stirring. Although no particular limitation is imposed on the concentration of the dispersion, the concentration of 5 to 30% by weight is preferred. This concentration range may be also preferrably applicable to the case where the enteric polymer is used not in a dispersion but in a solution having the enteric polymer dissoved in weakly alkali water such as aqueous ammonia.

In the present invention, the plasticizer liquid may be any one of only a plasticizer, a dispersion of the plasticizer, a solution of the plasticizer and a mixture of the plasticizer dispersion and plasticizer solution.

Examples of the plasticizer used in the present invention include triethyl citrate, tributyl citrate, tributyl acetylcitrate, triethyl acetylcitrate, propylene glycol, dipropylene glycol, triacetin, diacetin, monoacetin, benzyl alcohol, diethyl phthalate, dibutyl phthalate, glycerin phthalate, polyethylene glycol, polyoxyethylene alkyl ethers, polyethylene glycol fatty acid esters and propylene glycol fatty acid esters.

These plasticizers may be used either singly or in combination. They may be dispersed or dissolved in water prior to coating.

These plasticizers are added to improve the plasticity of the enteric polymer, thereby improving uniformity of the coating film. Although no particular limitation is imposed on the amount of the plasticizer insofar as it is enough to attain the improvement, a range of 5 to 60 wt % based on the amount of the enteric polymer is preferred.

The coating amount differs depending on the kind of the solid dosage form (solid preparation), but 3 to 50 wt %, in terms of solid coating portion, based on the weight of the solid dosage form is preferred. Prior to application to the solid dosage form, coating material, for example, a gastro-soluble coating material such as hydroxypropyl methyl cellulose may be applied to the solid dosage form. Consequently, enteric coating of the solid dosage form which tends to be broken by an impact can be also accomplished with even a small amount of coating material, while satisfying gastro-resistance.

Although no particular limitation is imposed on the form of the preparation to be coated, solid preparations such as tablets, granules and capsules are preferred for uniform coating.

Although a pan coating apparatus, a coating apparatus equipped with air drying mechanism or a fluid coating apparatus can be employed as a coating apparatus, it is necessary to use a spray gun of the present invention which can spray two liquids from separate nozzles.

The present invention will be described below in further details by Example. However, It should be construed that the present invention is not limited to the example.

### EXAMPLE 1

Coating was applied to tablets, each containing lactose, corn starch and Japanese Pharmacopoeia L-HPC (“LH-1” of Shin-Etsu Chemical Co., Ltd.), having a diameter of 8 mm and weight of 190 mg, under the below-described conditions. Thus, enteric coated tablets were obtained. As an enteric coating material, HPMCAS fine powders (“AS-MF” of Shin-Etsu Chemical Co., Ltd., having average particle size of 5 μm) were employed, while triethyl citrate was employed as a plasticizer.

The enteric polymer dispersion:

| | | |
|---|---|---|
| AS-MF | 15 | parts by weight |
| Talc | 4.5 | parts by weight |
| Water | 80.5 | parts by weight |
| Plasticizer: triethyl citrate | 100 | parts by weight |

Coating was conducted under the following operation conditions using the above two coating solutions.

Coating apparatus: “HICOATER HCT-48N” of Freund Inc.

Spray gun: having a similar structure to that illustrated in FIG. 1. Nozzle A having an inner diameter of 2.5 mm, and Nozzle B having an outer diameter of 2.0 mm and inner diameter of 1.0 mm were employed. Nozzles A and B, the enteric polymer dispersion and plasticizer were sprayed, respectively.

Transport pump

Gear pump for enteric polymer dispersion

Tube pump for plasticizer

Amount of tablets charged: 5 kg

Temperature of enteric polymer dispersion and plasticizer as coating liquids: 27° C.

Drying air temperature: 80° C.

Feed rate of air to spray gun: 140 liters/min

Feed rate of enteric polymer dispersion: 50 g/min

Feed rate of plasticizer: 2.1 g/min

Amounts of HPMCAS and triethyl citrate: corresponding to 100:28 (weight ratio)

Coating time: 80 minutes

Amount of HPMCAS: 600 g (12% based on tablets)

The enteric coated tablets thus obtained were found to have smooth and beautiful appearance. When disintegration test was made according to the Japanese Pharmacopoeia, they underwent no change at the test using a first liquid, but disintegrated completely in 9 to 12 minutes at the test using a second liquid. Thus, the obtained enteric coated tablets satisfied the requirement as an enteric preparation.

1. A spray gun for enteric coating, which is used for application of an enteric polymer dispersion and/or solution and a plasticizer solution as coating material to a preparation, comprising a nozzle for spraying the enteric polymer dispersion and/or solution, and a nozzle for spraying the plasticizer solution.

2. A process for producing an enteric coated preparation wherein an enteric polymer dispersion and/or solution and a plasticizer solution are simultaneously and separately sprayed to a preparation from said nozzles of said spray gun for enteric coating according to claim 1, thereby the preparation being coated.

3. A process for producing an enteric coated preparation according to claim 2, wherein said enteric polymer is selected from the group consisting of hydroxypropyl methyl cellulose phthalate, hydroxypropyl methyl cellulose acetate succinate, cellulose acetate phthalate, carboxymethyl ethyl cellulose, and a water dispersible copolymer obtained by emulsion polymerization of ethyl acrylate and methacrylic acid.

4. A process for producing an enteric coated preparation according to claim 2, wherein said plasticizer comprises triethyl citrate.

5. A process for producing an enteric coated preparation according to claim 3, wherein said plasticizer comprises triethyl citrate.
